(19) United States
(12) Patent Application Publication
(10) Pub. No.: US 2007/0276681 A1
(43) Pub. Date: Nov. 29, 2007

(54) Method Of Providing Bearer Certificates For Private Civil Security Benefits

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/550,594

(22) Filed: Oct. 18, 2006

Related U.S. Application Data
(63) Continuation-in-part of application No. 11/384,037, filed on Mar. 17, 2006.
(63) Continuation-in-part of application No. 11/394,350, filed on Mar. 30, 2006.
(63) Continuation-in-part of application No. 11/279,333, filed on Apr. 11, 2006.
(63) Continuation-in-part of application No. 11/379,929, filed on Apr. 24, 2006.
(63) Continuation-in-part of application No. 11/381,247, filed on May 2, 2006.
(63) Continuation-in-part of application No. 11/381,257, filed on May 2, 2006.
(63) Continuation-in-part of application No. 11/381,265, filed on May 2, 2006.
(63) Continuation-in-part of application No. 11/381,277, filed on May 2, 2006.
(63) Continuation-in-part of application No. 11/383,022, filed on May 12, 2006.
(63) Continuation-in-part of application No. 11/420,594, filed on May 26, 2006.
(63) Continuation-in-part of application No. 11/421,694, filed on Jun. 1, 2006.
(63) Continuation-in-part of application No. 11/423,594, filed on Jun. 12, 2006.
(63) Continuation-in-part of application No. 11/425,043, filed on Jun. 19, 2006.
(63) Continuation-in-part of application No. 11/426,231, filed on Jun. 23, 2006.
(63) Continuation-in-part of application No. 11/456,472, filed on Jul. 10, 2006.
(63) Continuation-in-part of application No. 11/461,605, filed on Aug. 1, 2006.
(63) Continuation-in-part of application No. 11/461,624, filed on Aug. 1, 2006.
(63) Continuation-in-part of application No. 11/462,795, filed on Aug. 7, 2006.
(63) Continuation-in-part of application No. 11/462,845, filed on Aug. 7, 2006.
(63) Continuation-in-part of application No. 11/464,751, filed on Aug. 15, 2006.
(63) Continuation-in-part of application No. 11/464,764, filed on Aug. 15, 2006.
(63) Continuation-in-part of application No. 11/464,775, filed on Aug. 15, 2006.
(63) Continuation-in-part of application No. 11/464,788, filed on Aug. 15, 2006.
(63) Continuation-in-part of application No. 11/464,799, filed on Aug. 15, 2006.
(63) Continuation-in-part of application No. 11/465,063, filed on Aug. 16, 2006.
(63) Continuation-in-part of application No. 11/466,727, filed on Aug. 23, 2006.
(63) Continuation-in-part of application No. 11/466,953, filed on Aug. 24, 2006.
(63) Continuation-in-part of application No. 11/470,156, filed on Sep. 5, 2006.
(63) Continuation-in-part of application No. 11/531,651, filed on Sep. 13, 2006.
(63) Continuation-in-part of application No. 11/532,461, filed on Sep. 15, 2006.
(63) Continuation-in-part of application No. 11/535,021, filed on Sep. 25, 2006.
(63) Continuation-in-part of application No. 11/535,282, filed on Sep. 26, 2006.
(63) Continuation-in-part of application No. 11/537,469, filed on Sep. 29, 2006.
(63) Continuation-in-part of application No. 11/539,798, filed on Oct. 9, 2006.
(63) Continuation-in-part of application No. 11/539,861, filed on Oct. 9, 2006.
(63) Continuation-in-part of application No. 11/548,191, filed on Oct. 10, 2006.
(63) Continuation-in-part of application No. 11/549,874, filed on Oct. 16, 2006.
(60) Provisional application No. 60/820,628, filed on Jul. 28, 2006.
(60) Provisional application No. 60/823,806, filed on Aug. 29, 2006.
(60) Provisional application No. 60/825,524, filed on Sep. 13, 2006.
(60) Provisional application No. 60/825,976, filed on Sep. 18, 2006.
(60) Provisional application No. 60/826,491, filed on Sep. 21, 2006.
(60) Provisional application No. 60/827,591, filed on Sep. 29, 2006.
(60) Provisional application No. 60/827,820, filed on Oct. 2, 2006.
(60) Provisional application No. 60/827,828, filed on Oct. 2, 2006.
(60) Provisional application No. 60/828,341, filed on Oct. 5, 2006.
(60) Provisional application No. 60/828,342, filed on Oct. 5, 2006.
(60) Provisional application No. 60/829,447, filed on Oct. 13, 2006.
(60) Provisional application No. 60/829,779, filed on Oct. 17, 2006.

(51) Int. Cl. G06Q 10/00; G06Q 30/00

(52) U.S. Cl. 705/1

(57) ABSTRACT

Consideration-based bearer certificates entitling a bearer to private civil security benefits are offered (105) and then provided (110) in exchange for consideration. The consideration-based bearer certificates may entitle a bearer to civilly-catastrophic event based access to a private civil security benefit. Benefits may also be provided prior to a civilly-catastrophic event. It is contemplated that the offeror of the consideration-based bearer certificates may also maintain (210) and/or provide private civil security benefits to authorized beneficiaries of consideration-based private civil security subscriptions. The benefits available to a bearer of the bearer certificates may vary. Similarly, the method of, manner of, or place for exchanging the bearer certificates for benefits may vary or be limited.

### RELATED APPLICATIONS

This application claims the benefit of the filing date of U.S. provisional application Nos. 60/820,628 filed on Jul. 28, 2006, 60/823,806 filed on Aug. 29, 2006, 60/825,524 filed on Sep. 13, 2006, 60/825,976 filed on Sep. 18, 2006, 60/826,491 filed on Sep. 29, 2006, 60/827,591 filed on Sep. 29, 2006, 60/827,820 filed on Oct. 2, 2006, 60/827,828 filed on Oct. 2, 2006, 60/828,341 filed on Oct. 5, 2006, 60/828,342 filed on Oct. 5, 2006, 60/829,447 filed on Oct. 13, 2006, and 60/829,779 filed on Oct. 17, 2006, which are hereby incorporated in their entirety herein.

This comprises a continuation-in-part of each of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application Ser. No. 11/464,751;

PRIVATELY PROVISIONED SURVIVAL SUPPLIES SUB-UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM-BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156;

METHOD OF PROVIDING A FLOATING LIFE-SUSTAINING FACILITY as filed on Sep. 13, 2006 and having application Ser. No. 11/531,651;

PRIVATELY PROVISIONED SUB-UNIT-BASED SURVIVAL SUPPLIES PROVISIONING METHOD as filed on Sep. 15, 2006 and having application Ser. No. 11/532,461;

PRIVATELY PROVISIONED INTERLOCKING SUB-UNIT-BASED SURVIVAL SUPPLIES PROVISIONING METHOD as filed on Sep. 25, 2006 and having application Ser. No. 11/535,021;

RESOURCE CONTAINER AND POSITIONING METHOD AND APPARATUS as filed on Sep. 26, 2006 and having application Ser. No. 11/535,282;

PUBLICLY-FUNDED PRIVATELY FACILITATED ACCESS TO SURVIVAL RESOURCES METHOD as filed on Sep. 29, 2006 and having application Ser. No. 11/537,469;

ELECTRICITY PROVIDING PRIVATELY PROVISIONED SUBSCRIPTION-BASED SURVIVAL SUPPLY UNIT METHOD AND APPARATUS as filed on Oct. 9, 2006 and having application Ser. No. 11/539,798;

PREMIUM-BASED CIVILLY-CATASTROPHIC EVENT THREAT ASSESSMENT as filed on Oct. 9, 2006 and having application Ser. No. 11/539,861;

PRIVATELY MANAGED ENTERTAINMENT AND RECREATION SUPPLIES PROVISIONING METHOD as filed on Oct. 10, 2006 and having application Ser. No. 11/548,191;

METHOD TO FACILITATE PROVIDING ACCESS TO A PLURALITY OF PRIVATE CIVIL SECURITY RESOURCE as filed on Oct. 16, 2006 and having application Ser. No. 11/549,874;

the contents of each of which are fully incorporated herein by this reference.

### TECHNICAL FIELD

This invention relates generally to providing access to emergency shelters and provisions.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or non-naturally-caused events can sufficiently disrupt society's infrastructure and ability to provide one or more life-sustaining resources such as water, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention, and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

### BRIEF DESCRIPTION OF THE DRAWINGS

The above needs are at least partially met through provision of the method of providing bearer certificates for private civil security benefits as described in the following detailed description in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a flow diagram of certain features in accordance with various embodiments of the invention; and

FIG. 4 comprises a flow diagram of certain features in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, consideration-based bearer certificates entitling a bearer to private civil security benefits are offered and then provided in exchange for consideration. The consideration-based bearer certificates may entitle a bearer to civilly-catastrophic event based access to a private civil security benefit. Benefits may also be provided prior to a civilly-catastrophic event. It is contemplated that the offeror of the consideration-based bearer certificates may also provide private civil security benefits to authorized beneficiaries of consideration-based private civil security subscriptions. The benefits available to a bearer of the bearer certificates may vary. Similarly, the method of, manner of, or place for exchanging or otherwise redeeming the bearer certificates for benefits may vary or be limited.

These steps are facilitated without dependency upon governmental oversight, participation, or control. The particular benefits to which the bearer certificates entitle the bearers can be tailored to the bearer's needs and requirements. Furthermore, the bearer certificates can be purchased for use by people other than subscribers or authorized beneficiaries who may otherwise be pre-entitled to private civil security benefits. Importantly, an individual can take important steps to bring a considerably improved measure of security into their lives or the lives of others without having to effectively become a full-time survivalist; such individuals can, in short, continue to enjoy their chosen vocations and standard of living knowing that, should a civilly-catastrophic event indeed be visited upon them, they will have extraordinary access to one or more resources that are critical to human life.

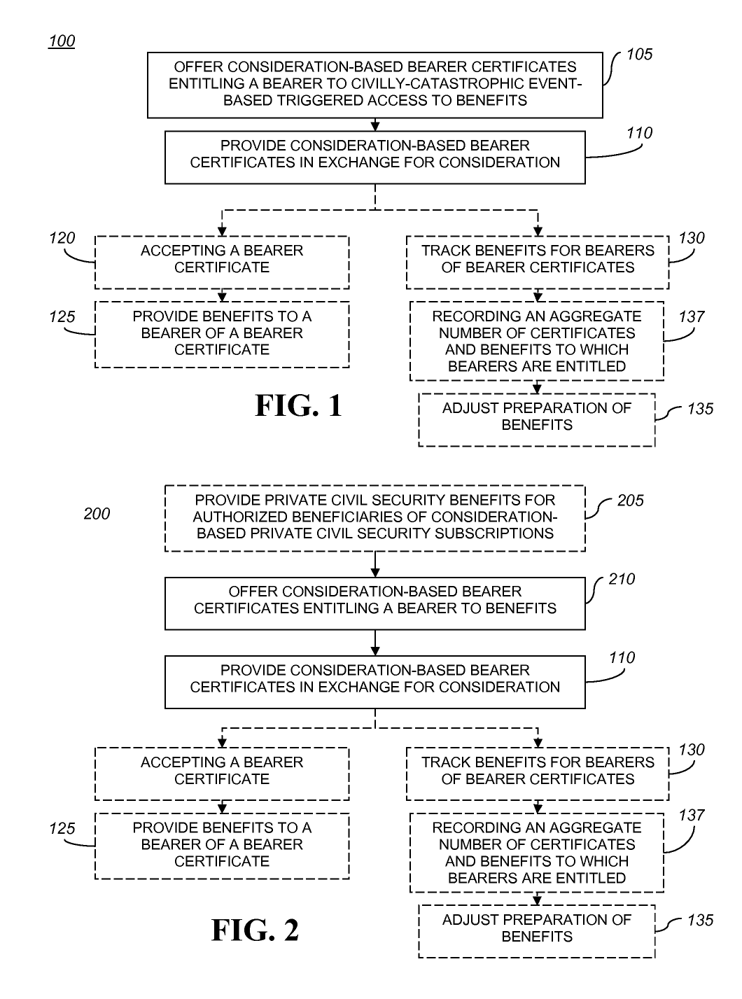

These and other benefits may become clearer upon making a thorough review and study of the following detailed description. Referring now to FIG. 1, an illustrative process 100 includes offering 105 consideration-based bearer certificates entitling a bearer of the bearer certificate to have civilly-catastrophic event-based triggered access to benefits and providing 110 at least one of the consideration-based bearer certificates to a party in exchange for consideration. This process allows the bearer of the certificate to exchange the certificate for civil security benefits upon the occurrence of a civilly-catastrophic event. In this approach, the provision of the bearer certificates need not be occasioned by or dependant upon the provision of benefits under another consideration-based model.

As used herein, “civilly-catastrophic event” will be understood to refer to an event that substantially and materially disrupts a society's local, regional, and/or national infrastructure and ability to provide in ordinary course for the at least one life-sustaining resource that is the subject of the bearer certificates. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or non-natural disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of non-natural disasters capable of initiating a civilly-catastrophic event include both unintended events as well as intentional acts of war, terrorism, madness or the like. Examples of non-natural disasters capable of such potential scale include, but are not limited to, nuclear-related events (including uncontrolled fission or fusion releases, radiation exposure, and so forth), acts of war, an intentional act of aggression, an unintentional act of aggression, an unintended event that results in public dispersal of a severe environmentally borne danger, the release of deadly or otherwise disruptive biological or chemical agents or creations, an event that results in widespread exposure to a mutagenic danger, and the like.

By another approach, with reference to FIG. 2, an illustrative process 200 includes selectively providing 205 and/or maintaining private civil security benefits to and/or maintaining private civil security benefits for authorized beneficiaries of consideration-based private civil security subscriptions obtained in anticipation of an occurrence of a civilly-catastrophic event, offering 210 consideration-based bearer certificates entitling a bearer of the bearer certificate to have access to at least one of the private civil security benefits, and providing 110 at least one of the consideration-based bearer certificates to a party in exchange for consideration. This process allows the bearer of the certificate to exchange the certificate for one or more private civil security benefits already available to authorized beneficiaries before or after the occurrence of a civilly-catastrophic event.

It is contemplated that a given subscriber may provide a subscription for access to the private civil security benefits for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

By one approach, these subscriptions may be accepted by, for example, a for-profit business. By another approach a not-for-profit business (such as a membership-based entity) may be the appropriate entity to offer and accept such subscriptions.

As noted, these teachings generally contemplate a subscription-based approach for the maintenance and provision of the private civil security benefits. As used herein, the term “subscription” shall be understood to refer to and encompass a variety of legal mechanisms. Some relevant examples include, but these teachings are not limited to, subscription mechanisms (wherein a “subscriber” has rights based on any one or more of the described example mechanisms) such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extends past the death of a named subscription beneficiary and further allows for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights in the at least one life-sustaining resource);

non-transferable rights of access (as may occur when the subscription, by its terms and conditions, prohibits transfer of the right of access to the at least one life-sustaining resource from a first named beneficiary to another);

transferable rights of access (as may occur when the subscription, by its terms and conditions, permits conditional or unconditional transfer of the right of access to the at least one life-sustaining resource from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access the at least one life-sustaining resource);

non-ownership-based rights of access (as may occur when the subscription, by its terms and conditions, establishes the aforementioned right of access via, for example, a lease, rental, or borrowing construct); and/or

option-based rights of access.

The bearer certificates provide an alternative to (and/or an embellishment of) the subscription approach. For instance, in various approaches, the bearer certificates may be purchased and/or used by any party. The party may be an authorized beneficiary, a subscriber, or a third-party. The bearer certificates then may be exchanged for private civil security benefits by someone other than a subscriber or authorized beneficiary.

Either of the above described illustrative processes 100 or 200, then, may include accepting 120 a bearer certificate and providing 125 benefits to the bearer of the bearer certificate. In one approach, the bearer certificate identifies at least one benefit to which the bearer is entitled. For instance, the bearer certificate may list several example benefits available to the bearer upon the exchange of the certificate. In another approach, the bearer may be limited to a particular benefit identified on the bearer certificate.

The entity providing or accepting the bearer certificate may provide the bearer certificate in a variety of ways. For instance, the bearer certificate may be an access card, as is generally known in the art. The bearer certificate access card then may be accepted 120 and benefit(s) provided 125 upon a tender of the access card regardless of who tenders the access card.

Another approach includes providing 125 benefit(s) only upon matching an identification of the bearer to the access card tendered by the bearer. In such an approach, the provider of benefits retains a record of the identifications of those entitled to benefits through bearer certificates. A similar approach includes where the bearer certificate is a record of the party who purchased the bearer certificate, and the offeror of the consideration-based bearer certificates stores the identifications such that benefits according to the bearer certificate are provided upon identification of the party. Such approaches may increase the security for those holding the bearer certificates.

Another approach includes providing a predetermined private civil security benefit upon tender of a bearer certificate as a default benefit. This approach would provide for the default benefit in lieu of or in addition to those benefits indicated on the bearer certificate. In another approach, the default benefit is provided even if the bearer's identity does not match the identity linked to that bearer certificate. Example default benefits may include at least one of a predetermined monetary value, a predetermined quantity of resources, a predetermined time of shelter, a predetermined emergency transportation service (for example away from a location experiencing significant civil turmoil as a result, at least in part, of a civilly-catastrophic event), or a unit of provisions sufficient for a predetermined time of use.

Moreover, depending on the form of the bearer certificate, the provider of the certificates may provide them in a variety of ways. For example, the consideration-based bearer certificates may be provided for purchase on a computer network, such as the Internet. Then, the bearer certificate may be printed out by the purchaser or separately delivered to the purchaser. Such a model may be more securely applied where the purchaser is a subscriber or authorized beneficiary with secure access to such purchasing networks. Alternatively, a party may purchase the bearer certificates in person in order to provide the appropriate identification and so forth as may be necessary to secure and exchange the bearer certificates.

By some approaches, the benefits or entitlements provided in exchange for bearer certificates may be provided only at predetermined locations. By limiting the number of places where benefits and entitlements are provided, the provider of the benefits can more reliably provide such benefits. Examples of such predetermined locations include a predetermined secure emergency shelter and/or provisions distribution center, a rally point, a regional emergency shelter and/or provisions distribution center, a metropolitan emergency shelter and/or provisions distribution center, a rural emergency shelter and/or provisions distribution center, and/or a national emergency shelter and/or provisions distribution center.

Under either of the above described illustrative processes 100 or 200, procedures for maintaining sufficient benefits to ensure their availability to bearers of the bearer certificates may be implemented. Thus, with reference again to FIGS. 1 and 2, the processes 100 or 200 may include tracking 130 an amount of the private civil security benefits to which bearers of bearer certificates are entitled and adjusting 135 the preparation of the private civil security benefits in response to the amount. This process may optionally include recording 137 an aggregate number of bearer certificates provided and the private civil security benefits to which bearers of the bearer certificates are entitled.

The step of adjusting 135 the preparation of the civil security benefits in response to the monitored bearer certificates and/or benefits conferred thereby will vary according to those benefits. Accordingly, the benefits and/or entitlements provided in exchange for the bearer certificates may vary as is appropriate for a given circumstance.

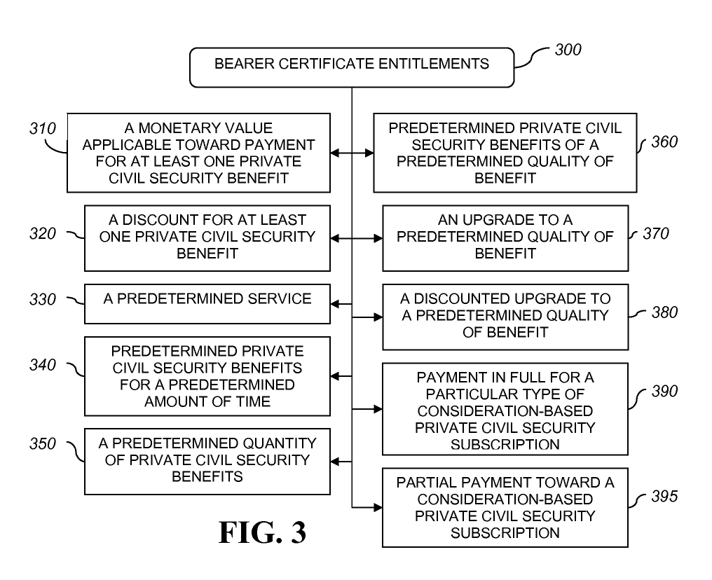

In various approaches, the bearer certificates may entitle the bearer to at least one of several possible bearer certificate entitlements 300 illustrated in FIG. 3. For instance, the bearer certificate may entitle a bearer to a monetary value 310 applicable toward payment for at least one private civil security benefit or a discount 320 for at least one private civil security benefit. The discount 320 could be a percent discount or a predetermined value amount discount that may be applied toward any civil security benefit. Other possibilities of course exist, such as a two-for-one styled promotion or the like.

By another approach, the bearer certificate may entitle the bearer to specific benefits. For example, the bearer certificate may entitle a bearer to a predetermined service 330, where, optionally, the predetermined service 330 is indicated by the bearer certificate. Example services include the provision of shelter, transport, training, and provisions as such services are discussed herein. These services can be provided upon the occurrence of a civilly-catastrophic event (such as the provision of shelter, transport, or provisions), or prior to the civilly-catastrophic event (such as the provision of training or provisions). In either case, the services are geared toward enhancing the prospects of surviving a civilly-catastrophic event for the bearer.

Similarly, the bearer certificate may entitle a bearer to predetermined private civil security benefits for a predetermined amount of time 340 or of a predetermined quantity 350 of private civil security benefits. Again, the private civil security benefit may be any one or more of shelter, provisions, training, or transport, any of which may be provided before or after the civilly-catastrophic event, depending on the arrangement. For example, a bearer certificate may entitle a bearer to access to a civil security shelter for a predetermined amount of time (a month, a year, and so forth) after the occurrence of a civilly-catastrophic event. Similarly, the bearer certificate may entitle a bearer to survival provisions of a predetermined amount (sufficient, for example, for a one year period, a two year period, and so forth) after the occurrence of a civilly-catastrophic event.

In certain approaches, the bearer certificate may entitle a bearer to predetermined private civil security benefits of a predetermined quality 360 of benefit. In such an arrangement, the bearer may be entitled to a higher quality shelter or provisions as a result of the type of bearer certificate used by the bearer. A modification to this approach includes where the bearer certificate may entitle the bearer to an upgrade 370 to a predetermined quality of benefit or a discounted upgrade 380 to a predetermined quality of benefit. Such a bearer certificate, then, may be used to upgrade a given level of subscription to which the bearer has access, or to upgrade a level of benefit to which the bearer has access through the use of a different bearer certificate.

By another approach, the bearer certificate may entitle a bearer to a consideration-based private civil security subscription 390 such that the illustrated processes 100 or 200 may include accepting the bearer certificate as payment for a particular type of consideration-based private civil security subscription. Further, the particular type of consideration-based private civil security subscription may be a level of subscription relative to a purchase price of the bearer certificate. Similarly, the bearer certificate may entitle a bearer to a partial subscription 395 with limited rights or as a partial payment for a subscription where one applies the bearer certificate as partial payment toward a consideration-based private civil security subscription for the bearer.

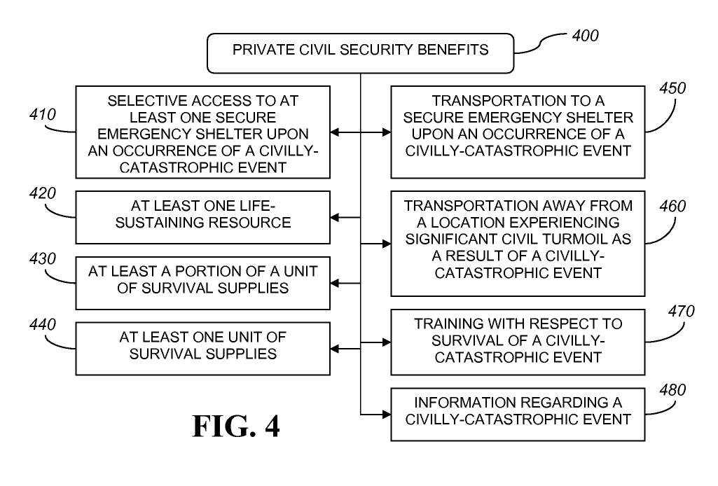

By other approaches, bearer certificates may allow the bearer access to one or more specific private civil security benefits 400 illustrated in FIG. 4. For instance, the private civil security benefit 400 to which a bearer may have access may include selective access 410 to at least one secure emergency shelter upon an occurrence of a civilly-catastrophic event. For example, the selective access to at least one secure emergency shelter upon an occurrence of a civilly-catastrophic event may include access to at least one secure emergency shelter for a predetermined number of days, for instance where the predetermined number of days of access is relative to the purchase value of the bearer certificate. Thus, a more expensive bearer certificate may allow a bearer more time of access to a shelter after a civilly-catastrophic event.

Similarly, the selective access 410 to shelter as provided by the bearer certificate may be immediate access to at least one secure emergency shelter upon presentment of the bearer certificate. It is contemplated that access to a given shelter may be selectively denied depending on the capacity of the shelter, and a bearer certificate, in this example, may allow the bearer to bypass this obstacle to shelter access. The selective access 410 to shelter may be provided in other ways such as by allowing the bearer access to only a predetermined secure emergency shelter.

By another approach, the selective access 410 to secure emergency shelters may include access to a predetermined level of benefits at the secure emergency shelter. The predetermined level of benefits may be selectively provided by selectively limiting the access of the bearer to predetermined areas or portions of the shelters or by limiting access to only specific secure emergency shelters. These ways of selectively providing access to secure emergency shelters allow the provider of the secure emergency shelters to better plan and more reliably provide shelter and resources upon the occurrence of a civilly-catastrophic event.

The predetermined level of benefits at the shelter may vary relative to the purchase value of the bearer certificate. The predetermined level of benefits may vary with respect to one or more of the following aspects of the shelter: a selection of foods, an amount of privacy available, a selection of non-necessities available, a selection of consumable items available, a selection of non-consumable items available, an amount of security, a method of transportation away from a location experiencing significant civil turmoil, a timing (which concept may include a priority of transport for the recipient of the service) of transportation away from a location experiencing significant civil turmoil, communications abilities, an availability of life sustaining provisions, a quality of living quarters, an availability of health care options, an availability of educational materials, and an availability of entertainment options, to note but a few examples in this regard.

Examples of how the predetermined level of benefits may vary with respect to the amount of privacy available include having private space such as personal hygiene facilities, personal storage space, personal food preparation facilities, personal external communications facilities, personal entertainment space, personal education space, personal training space, personal workshop space, personal worship facilities, personal sleeping space, personal space for copulation, and personal meeting facilities.

Example non-necessities as may be available include luxury consumable items; luxury non-consumable items; non-essential clothing; non-human nourishment; barter medium; entertainment apparatus; educational tools; physical conditioning, exercise, and maintenance training and equipment; crafts supplies and training; towels; bed linens; food preparation items; communication items; worship related items; data storage and retrieval apparatus; and sports equipment and facilities. Example consumable items as may be available include food supplies, potable water, medical supplies, contained breathable air, oxygen, and hygiene supplies to name but a few.

Example life sustaining resources as may be variable include hydration resources, nourishment resources, shelter, clothing, security, medical treatment, and environmentally borne threat abatement. Example ways in which the living quarters may vary include the availability and/or quality of sleeping accommodations, food preparation facilities, personal hygiene facilities, worship facilities, study facilities, and sitting accommodations. Example entertainment options that may vary at a secure emergency shelter include the availability and/or quality of a selection of videos (in any storage medium such as tape, DVD, digital storage, and the like), television (or other streaming content) reception, a selection of games, access to live entertainment, a selection of arts and crafts materials, religious-activity related facilities, a workshop space, and a selection of reading materials.

By another approach, the private civil security benefit 400 to which a bearer may have access may include at least one life-sustaining resource 420. Similarly, the private civil security benefit 400 to which a bearer may have access may include at least a portion of a unit of survival supplies 430 or at least one unit of survival supplies 440. It is contemplated that a standard unit of staple items including the most basic life sustaining resources will be available under those approaches. While a given bearer certificate may provide access to only the basic supplies, others may allow for tailoring the resources received in a unit. By one approach, such a standard unit can comprise the foundation or basic building block of the unit eventually provided for particular authorized beneficiaries or bearers of bearer certificates. Substitutions, alterations, and/or deletions to this basic unit will effect a change to the specific resources that a given authorized beneficiary or bearer will be provided. These teachings will accommodate an authorized beneficiary, or bearer of a bearer certificate allowing such upgrades, who requests so many upgrades that not a single item in the standard unit will be received by the authorized beneficiary. By another approach, the life-sustaining resources or survival supplies in a unit or partial unit are chosen individually or in an a la carte fashion such that an authorized beneficiary or bearer certificate bearer may only choose to have access to a few particular items for a certain period of time. As such, the benefit to a bearer may be a unit of survival supplies sufficient for a predetermined time of survival, where the predetermined time is a predetermined number of days in relation to a purchase value of the bearer certificate.

It is contemplated that the portion of a unit may be a sub-unit. Such sub-units may be characterized as a formation of resources into a plurality of discrete deliverable sub-units, wherein at least one of the sub-units comprises a quantity and selection of survival supplies as comprehensively correspond to the survival needs of the authorized beneficiary for a particular corresponding period of usage time. (As used herein, “comprehensively” will be understood to refer to a range of life-sustaining resources and non-necessity resources as will meet a corresponding range of anticipated needs.)

For instance, a sub-unit may be dedicated to a particular discrete category of survival supplies such as a nutritional and hydration supplies category, a shelter supplies category, a sundries category, a tools category, a medical and pharmaceutical supplies category, a clothing category, a communication category, an entertainment category, a camping category, a nutritional supplements and food preparation supplies category, a lighting category, a power generation category, a transportation apparatus and supplies category, and a self-defense supplies category to name a few. Another such category includes a nuclear, biological, and chemical threat-abatement supplies category. Similarly, the sub-unit may be provided as providing enough resources for a particular, or any given, category of time of survival such as a twenty-four hour supply kit, a seventy-two hour supply kit, a seven day supply kit, a ten day supply kit, a fourteen day supply kit, and a thirty day supply kit to name but a few.

By another approach, the portion of a unit may include storage of one or more of a plurality of life-sustaining resources. The plurality of life-sustaining resources may include hydration resources, nourishment resources, shelter, clothing, security, medical treatment, contained breathable air, and environmentally borne threat abatement. Similarly, the portion of a unit may include consumable survival supplies or non-consumable survival supplies.

Example consumable survival supplies may include food supplies, potable water, a finite air supply, medical supplies (examples may range from first aid supplies and emergency-room-caliber supplies to over the counter treatments such as calamine lotion, cough medicine, and the like), batteries, ammunition, hygiene supplies, sanitation supplies, consumable fishing supplies, signal flares, sunscreen lotion, anti-motion sickness medication, insect repellant, medications, reverse osmosis water filters, vehicular maintenance supplies (for example belts, pads, tires, filters, and the like), and vehicular fuel supplies. Example non-consumable survival supplies may include essential clothing items, personal protection items, bed linens, beds, food preparation items, communications items, power generation equipment, repair and maintenance tools, evacuation tools, navigation equipment, rescue tools and supplies, radiation shielding, biological/chemical agent protection, spare vehicle parts, self-rescue gear, vehicular maintenance tools, rope, life preservers, food gathering supplies, vision enhancement devices, and weapons.

Referring again to FIG. 4, the private civil security benefit 400 to which a bearer may have access may include transportation to at least one secure emergency shelter 450 upon an occurrence of a civilly-catastrophic event. Similarly the transportation benefit may be transportation away from a location 460 experiencing significant civil turmoil as a result, at least in part, of a civilly-catastrophic event. Such transportation would be designed to increase the personal safety of the recipient of the service. It is contemplated that the transportation benefits would be provided upon the occurrence of a civilly-catastrophic event, and may be provided regardless of the bearer's location. By another approach, the transportation may be provided only from predetermined locations (such as rally points, evacuation route transport stops, or the like), such that the bearer must get to such a location to gain access to the service.

Another private civil security benefit 400 to which a bearer may have access is training 470 with respect to survival of a civilly-catastrophic event. The training may encompass simple wilderness survival skills, combat training, technical training, or the like. Such training may also comprise training with respect to how one may best use their survival-related supplies, build an emergency shelter from commonly available materials, devise a personal set of contingency plans, and so forth. Numerous other possibilities exist in this regard.

Yet another private civil security benefit 400 to which a bearer may have access is information 480 regarding a civilly-catastrophic event. Information may be provided to a bearer of a bearer certificate upon verification of the bearer certificate via at least one of several ways including, for example, a telephone connection, a wireless communication, a visual signal, a smoke signal, a hand signal, and a computer network communication. For instance, the bearer certificate may come with an access code or password that the bearer may use over a telephone connection or wireless communication to obtain information about potential or actual threats as may be useful in predicting and/or avoiding a civilly-catastrophic event, information about an occurring civilly-catastrophic event, or information about how to avoid civil unrest or minimize personal danger as may occur after a civilly-catastrophic event.

Given the variety of options available, the private civil security benefit may generally include a predetermined quality of benefit relative to a purchase value of the bearer certificate. As such, any of the above options for the benefits as may be available to the bearer of a bearer certificate can be categorized into levels or classes of quality, and the bearer may then have access to only the class of benefits as identified on the bearer certificate or access to the given class of benefits and those classes of a lower quality.

In order to provide all of the above benefits and entitlements as may be available to a bearer of a bearer certificate, the provider of the benefits may adjust 135 the preparation of the benefits. This adjustment 135 may take as many forms as benefits and entitlements may exist. For example, the adjustment 135 may include preparing occupation space at least one secure emergency shelter for bearers of bearer certificates upon an occurrence of a civilly-catastrophic event. This preparation may include ensuring that the secure emergency shelters include sufficient space and resources for the authorized beneficiaries and bearers of bearer certificates as may have access to the particular shelters.

The preparation may include storing and maintaining at least one life-sustaining resource for bearers of bearer certificates, for example, in accordance the amount of resources to which the bearers may be entitled at any given time. Similarly, the preparation may include storing and maintaining at least a portion of a unit, or at least one unit, of survival supplies for bearers of bearer certificates.

The preparation may include preparing transportation to at least one secure emergency shelter upon an occurrence of a civilly-catastrophic event for bearers of bearer certificates and/or preparing transportation away from a location experiencing significant civil turmoil as a result, at least in part, of a civilly-catastrophic event for bearers of bearer certificates. The transportation preparation may include pre-provisioning and maintaining vehicles at certain locations as may provide adequate access to populated areas that may be affected by a civilly-catastrophic event. The vehicles may be armed or otherwise secured and rugged enough to be able to travel to predetermined rally points, to predetermined pick-up locations, and/or to the locations of bearers of bearer certificates entitling the bearers to such transportation.

The preparation of benefits may include preparing to provide training with respect to survival of a civilly-catastrophic event for bearers of bearer certificates. Preparing to provide training may include securing the services of experts in various fields to teach bearers of bearer certificates various skills such as survival skills, combat techniques, vehicle maintenance training, navigation, off-road vehicle handling, and the like.

The preparation of benefits for bearers of bearer certificates can include preparing for information dissemination to bearers of bearer certificates regarding a civilly-catastrophic event. Information dissemination may occur by any of several means including the examples discussed above. Thus, the preparation of those means may include preparing secure telephone connections with a bearer of the bearer certificate, providing reliable wireless communication with the bearer, establishing a computer network through which a bearer may access information, and the like.

Thus configured, various individuals may gain access to private civil security benefits and/or entitlements without having subscription-based access. The use of such certificates may provide additional options for providing access to specific entitlements to specific people or more generally to any bearer of such a certificate. The certificates may also then be used to provide an additional stream of revenue for such entities as may provide private civil security benefits.

Those skilled in the art will recognize that a wide variety of modifications, alterations, and combinations can be made with respect to the above described embodiments without departing from the spirit and scope of the invention. As but one example in this regard, bearer certificates may or may not be combined with each other or with subscription based access to private civil security benefits to provide access to more or higher quality benefits. Similarly, the bearer certificate may take on any of several forms as may be appropriate for the given benefit provided therewith. Such modifications, alterations, and combinations are to be viewed as being within the ambit of the inventive concept. As yet another example in this regard, the provider of such civil security benefits can make it a requirement that a given bearer of such a bearer certificate present themselves or otherwise register their bearer status prior to the occurrence of a civilly-catastrophic event in order to ensure that the bearer certificate will be honored upon the occurrence of such an event.

I claim:

1. A method comprising:
offering consideration-based bearer certificates that entitle a bearer of the bearer certificate to have civilly-catastrophic event-based triggered access to at least one private civil security benefit;
providing at least one of the consideration-based bearer certificates to a party in exchange for consideration.

2. The method of claim 1 wherein the party comprises an authorized beneficiary.

3. The method of claim 1 wherein the party comprises a subscriber.

4. The method of claim 1 wherein the party comprises a third-party.

5. The method of claim 1 further comprising:
tracking an amount of the at least one private civil security benefits to which bearers of bearer certificates are entitled;
adjusting preparation of the at least one private civil security benefits in response to the amount.

6. The method of claim 5 wherein tracking the amount of the at least one private civil security benefits to which bearers of bearer certificates are entitled further comprises recording an aggregate number of bearer certificates provided and the at least one private civil security benefits to which bearers of the bearer certificates are entitled.

7. The method of claim 5 wherein adjusting preparation of the at least one private civil security benefits in response to the amount comprises at least one of a group comprising:
preparing occupation space at least one secure emergency shelter for bearers of bearer certificates upon an occurrence of a civilly-catastrophic event;
storing and maintaining at least one life-sustaining resource for bearers of bearer certificates;
storing and maintaining at least a portion of a unit of survival supplies for bearers of bearer certificates;
storing and maintaining at least one unit of survival supplies for bearers of bearer certificates;
preparing transportation to at least one secure emergency shelter upon an occurrence of a civilly-catastrophic event for bearers of bearer certificates;
preparing transportation away from a location experiencing significant civil turmoil as a result, at least in part, of a civilly-catastrophic event for bearers of bearer certificates;
preparing to provide training with respect to survival of a civilly-catastrophic event for bearers of bearer certificates;
preparing for information dissemination to bearers of bearer certificates regarding a civilly-catastrophic event.

8. The method of claim 1 further comprising applying the bearer certificate as partial payment toward a consideration-based private civil security subscription for the bearer.

9. The method of claim 1 further comprising accepting the bearer certificate as payment for a particular type of consideration-based private civil security subscription.

10. The method of claim 9 wherein the particular type of consideration-based private civil security subscription further comprises a level of consideration-based private civil security subscription relative to a purchase price of the bearer certificate.

11. The method of claim 1 wherein the bearer certificate identifies a benefit to which the bearer is entitled.

12. The method of claim 1 wherein the bearer is limited to at least one benefit identified on the bearer certificate.

13. The method of claim 1 wherein the bearer certificates entitle the bearer to at least one of a group comprising:
a monetary value applicable toward payment for at least one private civil security benefit;
a discount for at least one private civil security benefit;
a predetermined service;
predetermined private civil security benefits for a predetermined amount of time;
predetermined private civil security benefits of a predetermined quality of benefit;
a predetermined quantity of private civil security benefits;
an upgrade to a predetermined quality of benefit;
a discounted upgrade to a predetermined quality of benefit.

14. The method of claim 13 wherein a private civil security benefit comprises at least one of a group comprising: shelter, provisions, training, and transport.

15. The method of claim 13 wherein the predetermined service is indicated by the bearer certificate.

16. The method of claim 13 wherein the predetermined service comprises at least one of a group comprising: provision of shelter, transport, training, and provisions.

17. The method of claim 14 wherein the discount comprises at least one of a percent discount and a predetermined value discount.

18. The method of claim 1 wherein the at least one private civil security benefit comprises a predetermined quality of benefit relative to a purchase value of the bearer certificate.

19. The method of claim 1 wherein the at least one private civil security benefit comprises at least one of a group comprising:
selective access to at least one secure emergency shelter upon an occurrence of a civilly-catastrophic event;
at least one life-sustaining resource;
at least a portion of a unit of survival supplies;
at least one unit of survival supplies;
transportation to at least one secure emergency shelter upon an occurrence of a civilly-catastrophic event;
transportation away from a location experiencing significant civil turmoil as a result, at least in part, of a civilly-catastrophic event;
training with respect to survival of a civilly-catastrophic event;
information regarding a civilly-catastrophic event.

20. The method of claim 19 wherein the selective access to at least one secure emergency shelter upon an occurrence of a civilly-catastrophic event further comprises access to at least one secure emergency shelter for a predetermined number of days.

21. The method of claim 20 wherein the predetermined number of days comprises a predetermined number of days of access relative to a purchase value of the bearer certificate.

22. The method of claim 19 wherein the selective access to at least one secure emergency shelter upon an occurrence of a civilly-catastrophic event further comprises immediate access to the at least one secure emergency shelter upon presentment of a bearer certificate.

23. The method of claim 19 wherein the selective access to at least one secure emergency shelter upon an occurrence of a civilly-catastrophic event further comprises access to only a predetermined at least one secure emergency shelter.

24. The method of claim 19 wherein the selective access to at least one secure emergency shelter upon an occurrence of a civilly-catastrophic event further comprises access to a predetermined level of benefits at the at least one secure emergency shelter.

25. The method of claim 24 wherein the predetermined level of benefits varies relative to a purchase value of the bearer certificate.

26. The method of claim 24 wherein the predetermined level of benefits varies with respect to at least one of a group comprising:
a selection of foods;
an amount of privacy available;
a selection of non-necessities available;
a selection of consumable items available;
a selection of non-consumable items available;
an amount of security;
a method of transportation away from a location experiencing significant civil turmoil as a result, at least in part, of a civilly-catastrophic event;
a timing of transportation away from a location experiencing significant civil turmoil as a result, at least in part, of a civilly-catastrophic event;
communications abilities;
an availability of life sustaining resources;
a quality of living quarters;
an availability of health care options;
an availability of educational materials; and
an availability of entertainment options.

27. The method of claim 26 wherein the predetermined level of benefits varies with respect to an amount of privacy available further comprises having an amount of private space comprising at least one of the group comprising:
personal hygiene facilities;
personal storage space;
personal food preparation facilities;
personal external communications facilities;
personal entertainment space;
personal education space;
personal training space;
personal workshop space;
personal worship facilities;
personal sleeping space;
personal space for copulation; and
personal meeting facilities.

28. The method of claim 26 wherein the non-necessities further comprise at least one of the group comprising:
luxury consumable items;
luxury non-consumable items;
non-essential clothing;
non-human nourishment;
barter medium;
entertainment apparatus;
educational tools;
physical conditioning, exercise, and maintenance training and equipment;
crafts supplies and training;
towels;
bed linens;
food preparation items;
communication items;
worship related items;
data storage and retrieval apparatus; and
sports equipment and facilities.

29. The method of claim 26 wherein the consumable items further comprise at least one of the group comprising:
food supplies;
potable water;
medical supplies;
contained breathable air;
oxygen; and
hygiene supplies.

30. The method of claim 26 wherein the life sustaining resources comprise at least one of the group comprising:
hydration resources;
nourishment resources;
shelter;
clothing;
security;
medical treatment; and
environmentally borne threat abatement.

31. The method of claim 26 wherein the living quarters comprise at least one of the group comprising:
sleeping accommodations;
food preparation facilities;
personal hygiene facilities;
worship facilities;
study facilities; and
sitting accommodations.

32. The method of claim 26 wherein the entertainment options available comprise at least one of the group comprising:
a selection of videos;
a quality of television reception;
a selection of games;
having access to live entertainment;
having a selection of arts and crafts materials;
having religious-activity related facilities;
a workshop space; and
a selection of reading materials.

33. The method of claim 19 wherein the portion of a unit comprising survival supplies further comprises a sub-unit.

34. The method of claim 33 wherein the sub-unit is dedicated to a particular discrete category of survival supplies comprising at least one of:
a nutritional and hydration supplies category;
a shelter supplies category;
a sundries category;
a tools category;
a medical and pharmaceutical supplies category;
a clothing category;
a communication category;
an entertainment category;
a camping category;
a nutritional supplements and food preparation supplies category;
a lighting category;
a power generation category;
a transportation apparatus and supplies category;
a self-defense supplies category;
a nuclear, biological, and chemical threat-abatement supplies category;
a twenty-four hour supply kit category;
a seventy-two hour supply kit category;
a seven day supply kit category;
a ten day supply kit category;
a fourteen day supply kit category; and
a thirty day supply kit category.

35. The method of claim 19 wherein the portion of a unit comprising survival supplies further comprises storage of one of a plurality of life-sustaining resources.

36. The method of claim 35 wherein the plurality of life-sustaining resources comprise at least one of:
hydration resources;
nourishment resources;
shelter;
clothing;
security;
medical treatment;
contained breathable air; and
environmentally borne threat abatement.

37. The method of claim 19 wherein the portion of a unit comprising survival supplies comprises at least one of:
consumable survival supplies; and
non-consumable survival supplies.

38. The method of claim 37 wherein the consumable survival supplies comprise at least one of:
food supplies;
potable water;
finite air supply;
medical supplies;
batteries;
ammunition;
hygiene supplies;
sanitation supplies;
consumable fishing supplies;
signal flares;
sunscreen lotion;
anti-motion sickness medication;
insect repellant;
medications;
reverse osmosis water filters;
vehicular maintenance supplies; and
vehicular fuel supplies.

39. The method of claim 37 wherein the non-consumable survival supplies comprise at least one of:
essential clothing items;
personal protection items;
bed linens;
beds;
food preparation items;
communications items;
power generation equipment;
repair and maintenance tools;
evacuation tools;
navigation equipment;
rescue tools and supplies;
radiation shielding;
biological/chemical agent protection;
spare vehicle parts;
self-rescue gear;
vehicular maintenance tools;
rope;
life preservers;
food gathering supplies;
vision enhancement devices; and
weapons.

40. The method of claim 19 wherein access to information with respect to survival of a civilly-catastrophic event further comprises providing information upon verification of the bearer certificate via at least one of the following:
a telephone connection;
a wireless communication;
visual signal;
smoke signal;
hand signal;
a computer network communication.

41. The method of claim 1 wherein the at least one private civil security benefit further comprises a unit of survival supplies sufficient for a predetermined time of survival.

42. The method of claim 41 wherein the predetermined time of survival comprises a predetermined number of days in relation to a purchase value of the bearer certificate.

43. The method of claim 1 wherein the bearer certificate comprises an access card.

44. The method of claim 43 wherein access to the at least one private civil security benefit is provided only upon matching an identification of the bearer to the access card tendered by the bearer.

45. The method of claim 43 wherein access to the at least one private civil security benefit is provided upon a tender of the access card.

46. The method of claim 1 further comprising providing the at least one private civil security benefit upon tender of the bearer certificate.

47. The method of claim 46 wherein the at least one private civil security benefit is provided regardless of an identity of the bearer.

48. The method of claim 46 wherein the at least one private civil security benefit comprises a default benefit provided regardless of at least one of a group comprising an identity of the bearer and a private civil security benefit identified on the bearer certificate.

49. The method of claim 48 wherein the default benefit comprises at least one of
a predetermined monetary value;
a predetermined quantity of resources;
a predetermined time of shelter;
a predetermined emergency transportation service; and
a unit sufficient for a predetermined time of use.

50. The method of claim 1 wherein the bearer certificate comprises a record of the party stored by an offeror of the consideration-based bearer certificates such that benefits according to the bearer certificate are provided upon identification of the party.

51. The method of claim 1 wherein access to the at least one private civil security benefit is provided only at predetermined locations.

52. The method of claim 51 wherein the predetermined locations comprise at least one a group comprising:
a predetermined secure emergency shelter;
a rally point;
regional emergency shelter;
metropolitan emergency shelter;
rural emergency shelter;
national emergency shelter.

53. The method of claim 1 wherein providing at least one of the consideration-based bearer certificates to a party in exchange for consideration further comprises providing the consideration-based bearer certificates for purchase on a computer network.

54. A method comprising:
selectively providing private civil security benefits to authorized beneficiaries of consideration-based private civil security subscriptions obtained in anticipation of an occurrence of a civilly-catastrophic event;
offering consideration-based bearer certificates that entitle a bearer of the bearer certificate to have access to at least one of the private civil security benefits;
providing at least one of the consideration-based bearer certificates to a party in exchange for consideration.

55. The method of claim 54 wherein the party comprises an authorized beneficiary.

56. The method of claim 54 wherein the party comprises a subscriber.

57. The method of claim 54 wherein the party comprises a third-party.

58. The method of claim 54 further comprising:
tracking an amount of the at least one private civil security benefits to which bearers of bearer certificates are entitled;
adjusting preparation of the at least one private civil security benefits in response to the amount.

59. The method of claim 58 wherein tracking the amount of the at least one private civil security benefits to which bearers of bearer certificates are entitled further comprises recording an aggregate number of bearer certificates provided and the at least one private civil security benefits to which bearers of the bearer certificates are entitled.

60. The method of claim 58 wherein adjusting preparation of the at least one private civil security benefits in response to the amount comprises at least one of a group comprising:
preparing occupation space at least one secure emergency shelter for bearers of bearer certificates upon an occurrence of a civilly-catastrophic event;
storing and maintaining at least one life-sustaining resource for bearers of bearer certificates;
storing and maintaining at least a portion of a unit of survival supplies for bearers of bearer certificates;
storing and maintaining at least one unit of survival supplies for bearers of bearer certificates;
preparing transportation to at least one secure emergency shelter upon an occurrence of a civilly-catastrophic event for bearers of bearer certificates;
preparing transportation away from a location experiencing significant civil turmoil as a result, at least in part, of a civilly-catastrophic event for bearers of bearer certificates;
preparing to provide training with respect to survival of a civilly-catastrophic event for bearers of bearer certificates;
preparing for information dissemination to bearers of bearer certificates regarding a civilly-catastrophic event.

61. The method of claim 54 wherein the at least one of the private civil security benefit comprises a predetermined quality of benefit relative to a purchase value of the bearer certificate.

62. The method of claim 54 further comprising applying the bearer certificate as partial payment toward a consideration-based private civil security subscription for the bearer.

63. The method of claim 54 further comprising accepting the bearer certificate as payment for a particular type of consideration-based private civil security subscription.

64. The method of claim 63 wherein the particular type of consideration-based private civil security subscription further comprises a level of consideration-based private civil security subscription relative to a purchase price of the bearer certificate.

65. The method of claim 54 wherein the bearer certificate identifies a benefit to which the bearer is entitled.

66. The method of claim 54 wherein the bearer is limited to at least one benefit identified on the bearer certificate.

67. The method of claim 54 wherein the bearer certificates entitle the bearer to at least one of a group comprising:
a monetary value applicable toward payment for at least one private civil security benefit;
a discount for at least one private civil security benefit;
a predetermined service;
predetermined private civil security benefits for a predetermined amount of time;
predetermined private civil security benefits of a predetermined quality of benefit;
a predetermined quantity of private civil security benefits;
an upgrade to a predetermined quality of benefit;
a discounted upgrade to a predetermined quality of benefit.

68. The method of claim 67 wherein a private civil security benefit comprises at least one of a group comprising: shelter, provisions, training, and transport.

69. The method of claim 67 wherein the predetermined service is indicated by the bearer certificate.

70. The method of claim 67 wherein the predetermined service comprises at least one of a group comprising: provision of shelter, transport, training, and provisions.

71. The method of claim 67 wherein the discount comprises at least one of a percent discount and a predetermined value discount.

72. The method of claim 54 wherein the at least one of the private civil security benefits comprises at least one of a group comprising:
selective access to at least one secure emergency shelter upon an occurrence of a civilly-catastrophic event;
at least one life-sustaining resource;
at least a portion of a unit of survival supplies;
at least one unit of survival supplies;
transportation to at least one secure emergency shelter upon an occurrence of a civilly-catastrophic event;
transportation away from a location experiencing significant civil turmoil as a result, at least in part, of a civilly-catastrophic event;
training with respect to survival of a civilly-catastrophic event;
information regarding a civilly-catastrophic event.

73. The method of claim 72 wherein the selective access to at least one secure emergency shelter upon an occurrence of a civilly-catastrophic event further comprises access to at least one secure emergency shelter for a predetermined number of days.

74. The method of claim 73 wherein the predetermined number of days comprises a predetermined number of days of access relative to a purchase value of the bearer certificate.

75. The method of claim 72 wherein the selective access to at least one secure emergency shelter upon an occurrence of a civilly-catastrophic event further comprises immediate access to the at least one secure emergency shelter upon presentment of a bearer certificate.

76. The method of claim 72 wherein the selective access to at least one secure emergency shelter upon an occurrence of a civilly-catastrophic event further comprises access to only a predetermined at least one secure emergency shelter.

77. The method of claim 72 wherein the selective access to at least one secure emergency shelter upon an occurrence of a civilly-catastrophic event further comprises access to a predetermined level of benefits at the at least one secure emergency shelter.

78. The method of claim 77 wherein the predetermined level of benefits varies relative to a purchase value of the bearer certificate.

79. The method of claim 77 wherein the predetermined level of benefits varies with respect to at least one of a group comprising:
a selection of foods;
an amount of privacy available;
a selection of non-necessities available;
a selection of consumable items available;
a selection of non-consumable items available;
an amount of security;
a method of transportation away from a location experiencing significant civil turmoil as a result, at least in part, of a civilly-catastrophic event;
a timing of transportation away from a location experiencing significant civil turmoil as a result, at least in part, of a civilly-catastrophic event;
communications abilities;
an availability of life sustaining resources;
a quality of living quarters;
an availability of health care options;
an availability of educational materials; and
an availability of entertainment options.

80. The method of claim 79 wherein the predetermined level of benefits varies with respect to an amount of privacy available further comprises having an amount of private space comprising at least one of the group comprising:
personal hygiene facilities;
personal storage space;
personal food preparation facilities;
personal external communications facilities;
personal entertainment space;
personal education space;
personal training space;
personal workshop space;
personal worship facilities;
personal sleeping space;
personal space for copulation; and
personal meeting facilities.

81. The method of claim 79 wherein the non-necessities further comprise at least one of the group comprising:
luxury consumable items;
luxury non-consumable items;
non-essential clothing;
non-human nourishment;
barter medium;
entertainment apparatus;
educational tools;
physical conditioning, exercise, and maintenance training and equipment;
crafts supplies and training;
towels;
bed linens;
food preparation items;
communication items;
worship related items;
data storage and retrieval apparatus; and
sports equipment and facilities.

82. The method of claim 79 wherein the consumable items further comprise at least one of the group comprising:
food supplies;
potable water;
medical supplies;
contained breathable air;
oxygen; and
hygiene supplies.

83. The method of claim 79 wherein the life sustaining resources comprise at least one of the group comprising:
hydration resources;
nourishment resources;
shelter;
clothing;
security;
medical treatment; and
environmentally borne threat abatement.

84. The method of claim 79 wherein the living quarters comprise at least one of the group comprising:
sleeping accommodations;
food preparation facilities;
personal hygiene facilities;
worship facilities;
study facilities; and
sitting accommodations.

85. The method of claim 79 wherein the entertainment options available comprise at least one of the group comprising:
a selection of videos;
a quality of television reception;
a selection of games;
having access to live entertainment;
having a selection of arts and crafts materials;
having religious-activity related facilities;
a workshop space; and
a selection of reading materials.

86. The method of claim 72 wherein the portion of a unit comprising survival supplies further comprises a sub-unit.

87. The method of claim 86 wherein the sub-unit is dedicated to a particular discrete category of survival supplies comprising at least one of:
a nutritional and hydration supplies category;
a shelter supplies category;
a sundries category;
a tools category;
a medical and pharmaceutical supplies category;
a clothing category;
a communication category;
an entertainment category;
a camping category;
a nutritional supplements and food preparation supplies category;
a lighting category;
a power generation category;
a transportation apparatus and supplies category;
a self-defense supplies category;
a nuclear, biological, and chemical threat-abatement supplies category;
a twenty-four hour supply kit category;
a seventy-two hour supply kit category;
a seven day supply kit category;
a ten day supply kit category;
a fourteen day supply kit category; and
a thirty day supply kit category.

88. The method of claim 72 wherein the portion of a unit comprising survival supplies further comprises storage of one of a plurality of life-sustaining resources.

89. The method of claim 88 wherein the plurality of life-sustaining resources comprise at least one of:
hydration resources;
nourishment resources;
shelter;
clothing;
security;
medical treatment;
contained breathable air; and
environmentally borne threat abatement.

90. The method of claim 72 wherein the portion of a unit comprising survival supplies comprises at least one of:
consumable survival supplies; and
non-consumable survival supplies.

91. The method of claim 90 wherein the consumable survival supplies comprise at least one of:
food supplies;
potable water;
finite air supply;
emergency medical supplies;
batteries;
ammunition;
hygiene supplies;
sanitation supplies;
consumable fishing supplies;
signal flares;
sunscreen lotion;
anti-motion sickness medication;
insect repellant;
medications;
reverse osmosis water filters;
vehicular maintenance supplies; and
vehicular fuel supplies.

92. The method of claim 90 wherein the non-consumable survival supplies comprise at least one of:
essential clothing items;
personal protection items;
bed linens;
beds;
food preparation items;
communications items;
power generation equipment;
repair and maintenance tools;
evacuation tools;
navigation equipment;
rescue tools and supplies;
radiation shielding;
biological/chemical agent protection;
spare vehicle parts;
self-rescue gear;
vehicular maintenance tools;
rope;
life preservers;
food gathering supplies;
vision enhancement devices; and
weapons.

93. The method of claim 72 wherein access to information with respect to survival of a civilly-catastrophic event further comprises providing information upon verification of the bearer certificate via at least one of the following:
a telephone connection;
a wireless communication;
visual signal;
smoke signal;
hand signal;
a computer network communication.

94. The method of claim 54 wherein the at least one of the private civil security benefits further comprises a unit of survival supplies sufficient for a predetermined time of survival.

95. The method of claim 94 wherein the predetermined time of survival comprises a predetermined number of days in relation to a purchase value of the bearer certificate.

96. The method of claim 54 wherein the bearer certificate comprises an access card.

97. The method of claim 96 wherein access to the at least one private civil security benefit is provided only upon matching an identification of the bearer to the access card tendered by the bearer.

98. The method of claim 96 wherein access to the at least one private civil security benefit is provided upon a tender of the access card.

99. The method of claim 54 wherein the bearer certificate comprises a record of the party stored by an offeror of the consideration-based bearer certificates such that benefits according to the bearer certificate are provided upon identification of the party.

100. The method of claim 54 further comprising providing the at least one private civil security benefit upon tender of the bearer certificate.

101. The method of claim 100 wherein the at least one private civil security benefit is provided regardless of an identity of the bearer.

102. The method of claim 100 wherein the at least one private civil security benefit comprises a default benefit provided regardless of at least one of a group comprising an identity of the bearer and a private civil security benefit identified on the bearer certificate.

103. The method of claim 102 wherein the default benefit comprises at least one of
a predetermined monetary value;
a predetermined quantity of resources;
a predetermined time of shelter;
a predetermined emergency transportation service; and
a unit sufficient for a predetermined time of use.

104. The method of claim 54 wherein access to the at least one of the private civil security benefits is provided only at predetermined locations.

105. The method of claim 104 wherein the predetermined locations comprise at least one a group comprising:
a predetermined secure emergency shelter;
a rally point;
regional emergency shelter;
metropolitan emergency shelter;
rural emergency shelter;
national emergency shelter.

106. The method of claim 54 wherein providing at least one of the consideration-based bearer certificates to a party in exchange for consideration further comprises providing the consideration-based bearer certificates for purchase on a computer network.

107. The method of claim 106 further comprising providing the ability to print the consideration-based bearer certificate.

108. The method of claim 53 further comprising providing the ability to print the consideration-based bearer certificate.
